(19) United States
(12) Patent Application Publication
(10) Pub. No.: US 2017/0314901 A1
(43) Pub. Date: Nov. 2, 2017

(54) SYSTEM AND METHOD FOR MAKING SOFT PROJECTILES

(71) Applicant: PAPER SHOOTERS LIMITED, Manchester (GB)

(72) Inventor: MICHAEL A. HOWARTH, MANCHESTER (GB)

(21) Appl. No.: 15/140,106

(22) Filed: Apr. 27, 2016

(51) Int. Cl. F42B 33/00; B29C 43/50; B29C 43/56; B31F 1/00; F42B 6/00; B29C 43/36; B29C 43/02; B29K 105/00; B29L 31/52

(52) U.S. Cl. CPC F42B 33/00; B29C 43/36; B29C 43/50; B29C 43/56; B31F 1/0077; B29C 43/02; F42B 6/00; B29C 2043/567; B29L 2031/5209; B29L 2031/529; B29K 2105/0058

(57) ABSTRACT

The present invention discloses a system and method for making soft projectiles for use with toy and recreational firearms, the system and method comprising of a mold and a projectile material, the mold comprising of a first plate with one or more protrusions and a second plate with one or more cavities, the second plate mated with the first plate to form one or more soft projectiles.

### BACKGROUND OF THE INVENTION

### Field of the Invention

The present invention relates generally to a system and method of making projectiles and more specifically to a system and method of making soft projectiles for use with toy and recreational firearms.

### Related Art

The use of soft projectiles in the toy and recreational firearm industry is becoming increasingly popular. Because of the materials they are typically made of, such as foam, plastic or a combination thereof, soft projectiles reduce the chance of injury and are less painful on contact. Soft projectiles are formed using molds or can be handmade. Current projectile and ammunition molds are heavy and require the use of molten metals or excessive heat and therefore are not safe for a child or amateur user. While these current molds are effective, they are heavy, lack safety and ease of use.

What is needed is a convenient, safe and easy to use system and method for making toy and recreational projectiles which is appropriate for the at home user as well as for use on an industrial level.

### SUMMARY OF THE INVENTION

It is to be understood that the phraseology and terminology employed herein are for the purpose of the description and should not be regarded as limiting.

In light of the above mentioned disadvantages in the prior art, the present invention discloses a safe and easy to use system and method of making soft projectiles for use with toys and recreational firearms. The system and method comprising of a projectile mold and projectile material. The projectile mold comprising of a first plate having one or more protrusions on its downward facing side, a second plate having one or more cavities with openings on its upward facing side, a projectile material for insertion into the cavities of the second plate, the second plate mated with the first plate to form one or more soft projectiles from the projectile material. The protrusions of the first plate inserted into base openings at the base of the cavities of the second plate, pushing the soft projectiles out of the projectile mold.

### BRIEF DESCRIPTION OF THE DRAWINGS

Embodiments of the present invention will be described by way of example only, and not limitation, with reference to the accompanying drawings in which:

FIG. 1 is a perspective view of a system for making soft projectiles according to one embodiment of the present invention;

FIG. 2 is a perspective view of a system and method for making soft projectiles according to one embodiment of the present invention;

FIG. 3 is a perspective view of a system and method of making soft projectiles according to one embodiment of the present invention;

FIG. 4 is a perspective view of a system and method of making soft projectiles according to one embodiment of the present invention;

FIG. 5 is a perspective view of a system and method of making soft projectiles according to one embodiment of the present invention;

FIG. 6 is a perspective view of a projectile mold according to one embodiment of the present invention;

FIG. 7 is a perspective view of a projectile mold according to one embodiment of the present invention; and

FIG. 8 is a perspective view of a system and method of making soft projectiles according to one embodiment of the present invention;

### DETAILED DESCRIPTION

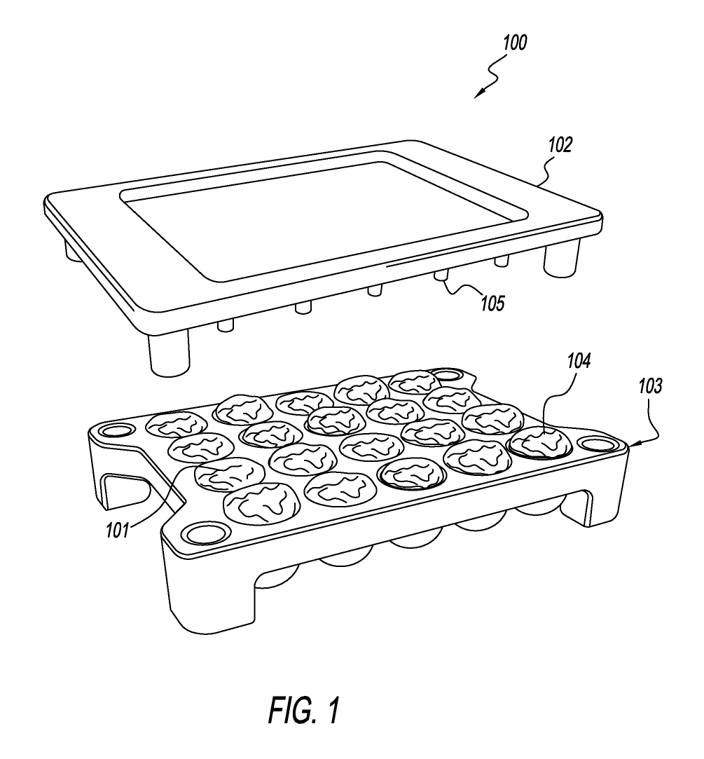

Referring now to the figures, where similar reference characters denote similar elements throughout the figures, FIG. 1 shows a perspective view of a system for creating soft projectiles for use in toy and recreational firearms, the system comprising of a projectile mold 100 and projectile material 101. The projectile material 101 is the material from which the soft projectiles are made. Examples of projectile materials 101 may include, but are not limited to, tissue paper, paper towel, writing paper, soft putty, or other materials which are easily moldable into a structured form, with or without the application of a liquid. The projectile mold 100 comprising of a first plate 102 and a second plate 103. The first plate 102 comprising of one or more protrusions 105 on its downward facing side for assisting with formation of the soft projectiles. The second plate 103 comprising of one or more cavities 104 with openings on its upward facing side for holding and creating the shape of the soft projectiles. The one or more cavities 104 are preferably cup shaped but can take any shape adequate to form soft projectiles of shapes generally known in the art. The base of the one or more cavities 104 comprises of base openings 110, such base openings 110 being sufficiently wide to fit the protrusions 105 of the first plate 102. In a preferred embodiment of the present invention the projectile mold 100 comprises of an equal number of cavities 104, base openings 110 and protrusions 105. The projectile mold 100 is made of a sturdy material examples of which include, but are not limited to, hard plastic, metal, rubber, or other sturdy materials typically known in the art for the making of toy and recreational firearms and firearm accessories.

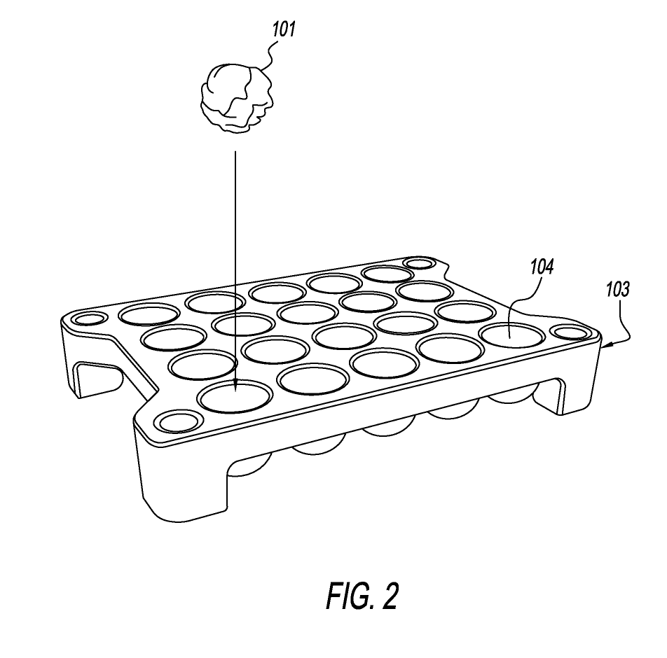

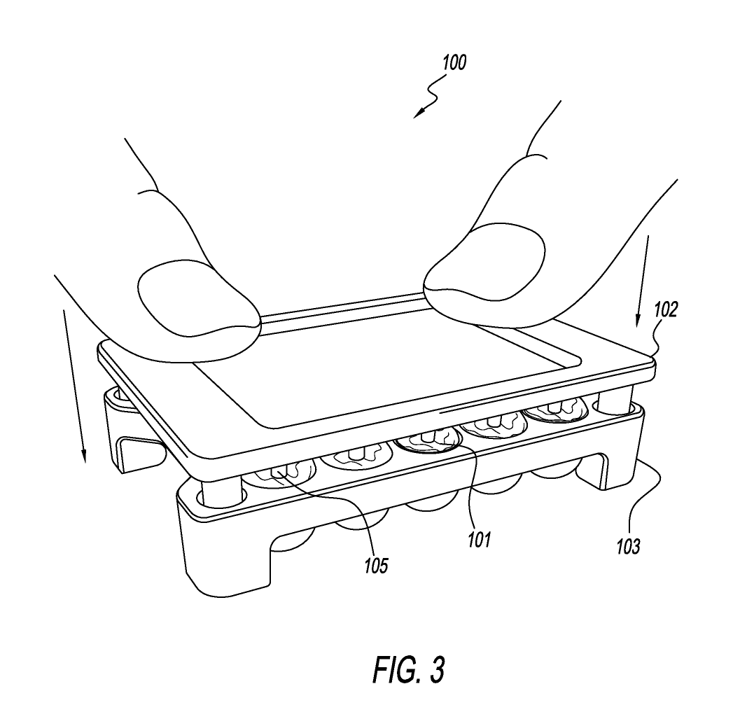

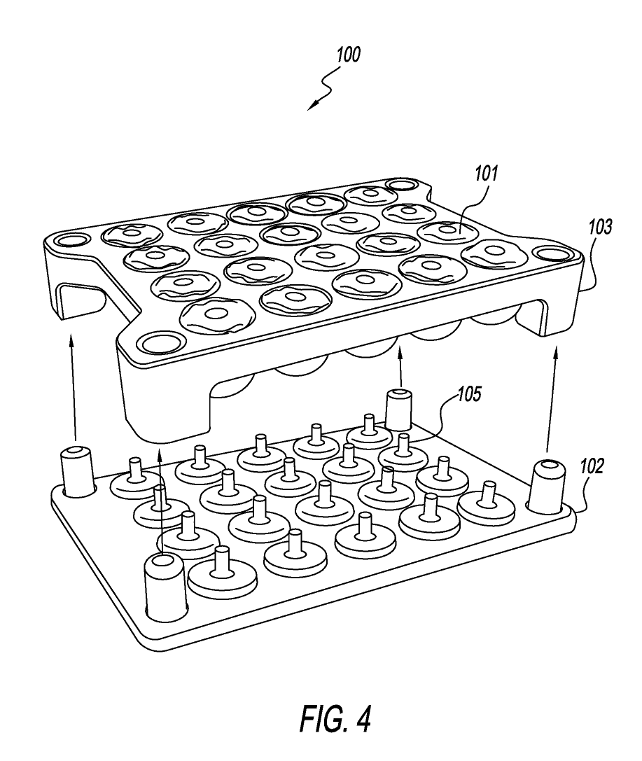

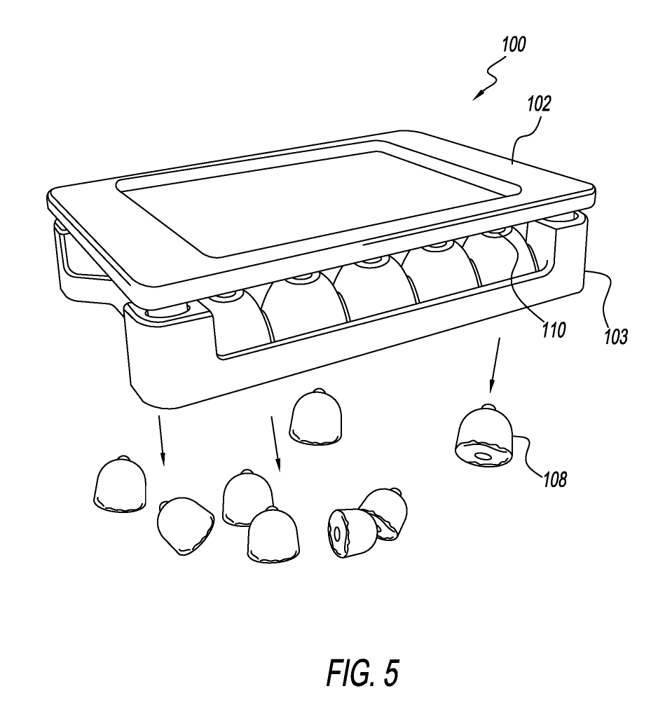

The soft projectiles 108 are formed by inserting the projectile material 101 into the one or more cavities 104 of the second plate 103 as shown in FIG. 2, lining up and contacting the one or more protrusions 105 of the first plate 102 with the one of more cavities 104 of the second plate 103 and firmly squeezing the first plate 102 and the second plate 103 together for a length of time sufficient to allow the projectile material 101 to maintain its molded shape, as shown in FIG. 3. The length of time is determined by the type of projectile material 101 used and is in accordance with the time, generally known in the art, that it typically takes that specific material to maintain a shape when molded. Referring now to FIGS. 4 and 5, the soft projectiles 108 are removed from the projectile mold 100 by separating the first plate 102 from the second plate 103, aligning the one or more protrusions 105 of the first plate 102 with the base openings 110 of the one or more cavities 104 of the second plate 103 and inserting the one or more protrusions 105 into the one or more base openings 110 causing the soft projectiles 108 to be pushed out of the one or more cavities 104.

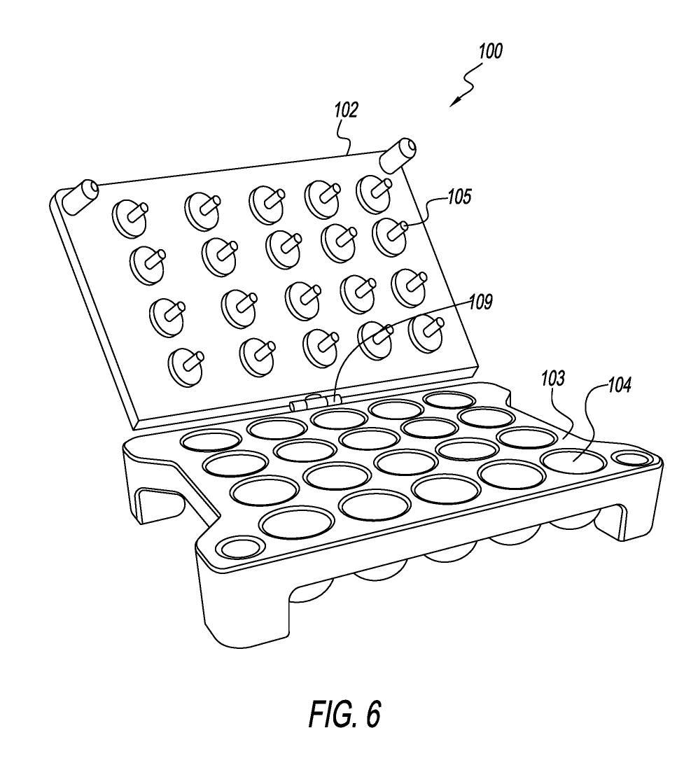

In one embodiment of the present invention as shown in FIG. 6, the projectile mold 100 has a hinge 109 connecting the first plate 102 to the second plate 103. The hinge 109 preferably allows the first plate 102 to rotate around the second plate 103 at least 180 degrees vertically, and 360 degrees horizontally. The preferred hinge 109 allows the first plate 102 to rotate sufficiently to allow the protrusions 105 to make contact with and be inserted into the base openings 110 of the second plate 103 for pushing the soft projectiles 108 out of the one or more cavities 104.

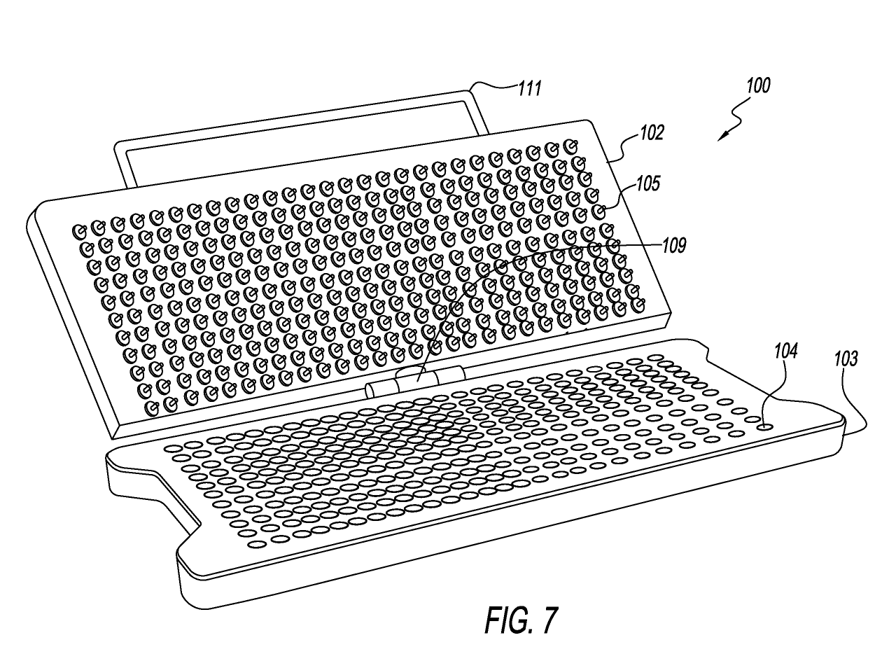

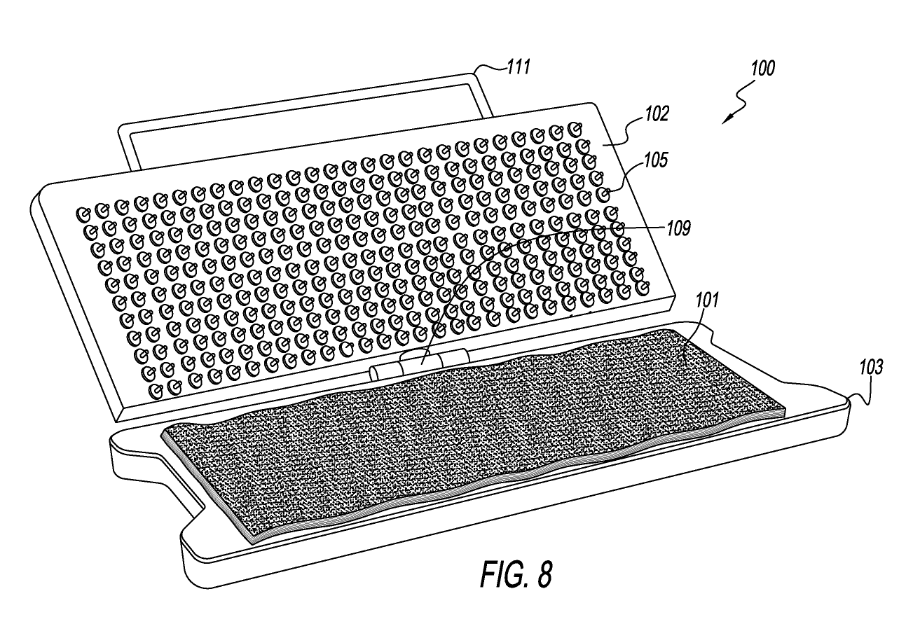

In another embodiment of the present invention, a non-limiting example of which is shown in FIG. 7, the projectile mold 100 further comprises of a lever 111 for controlling the movement of the first plate 102 and for firmly pressing the first plate 102 onto the second plate 103 forming several soft projectiles 108 from the projectile material 101. In this embodiment of the present invention, as exemplified in FIG. 8, the soft projectiles 108 are formed by vertically laying layers of the projectile material 101 across the upward facing surface of the second plate 103, using the lever 111 to contact the first plate 102 with the second plate 103 firmly squeezing the first plate 102 and the second plate 103 together for a length of time sufficient to allow the projectile material 101 to maintain its molded shape. The length of time is determined by the type of projectile material 101 used and is in accordance with the time, generally known in the art, that it typically takes that specific material to maintain a shape when molded. The protrusions 105 having edges sufficiently sharp to cut the vertically layered projectile material 101, upon contact and application of pressure, such that the projectile material is divided into sections which are pushed into the cavities, these sections used to form the soft projectiles.

The soft projectiles 108 are removed from the projectile mold 100 by rotating the first plate 102 on the hinge 109 180 degrees vertically and 360 degrees horizontally around the second plate 103, aligning the protrusions 105 of the first plate 102 with the base openings 110 of the cavities 104 of the second plate 103 and inserting the protrusions 105 into the base openings 110 causing the soft projectiles 108 to be pushed out of the cavities 104.

In some embodiments of the present invention, the projectile mold 100 comprises of a clip for securing the first plate 102 to the second plate 103 while waiting for the projectile material 101 to take the molded form of the soft projectiles 108. In some embodiments of the present invention a liquid is applied to the projectile material to assist in the formation of the soft projectiles 108.

What is claimed is:

1. A system for making soft projectiles, the system comprising:
(a) A mold, comprising:
a first plate, comprising of one or more protrusions; and
a second plate, comprising of one or more cavities, the second plate when mated with the first plate forming one or more soft projectiles; and
(b) A projectile material for forming one or more soft projectiles.

2. A mold for making soft projectiles, the mold comprising:
a first plate comprising of one or more protrusions; and
a second plate comprising of one or more cavities, the second plate when mated with the first plate forming one or more soft projectiles.

3. A mold for making soft projectiles, the mold comprising:
a first plate comprising of one or more protrusions;
a second plate comprising of one or more cavities, the second plate when mated with the first plate forming one or more soft projectiles; and
a base opening at the base of each of the one or more cavities, each base opening being sufficiently wide to fit a protrusion of the first plate.

4. The mold of claim 2, further comprising a hinge coupling the first plate to the second plate.

5. The mold of claim 3, further comprising a hinge coupling the first plate with the second plate.

6. The mold of claims 4, further comprising a lever for mating the first plate with the second plate.

7. The mold of claim 5, further comprising a lever for mating the first plate with the second plate.

8. The mold of claim 7, wherein the hinge allows the first plate to be rotated at least 180 degrees vertically and up to 360 degrees horizontally.

9. A method of making soft projectiles, comprising:
selecting the mold of claim 3;
inserting a projectile material into the one or more cavities;
pressing the first plate against the second plate for a period sufficiently long to cause the projectile material to maintain a molded shape;
removing the first plate from contacting the second plate; and
inserting the one or more protrusions of the first plate into the base openings of the second plate, pushing the soft projectiles out of the mold.

10. The method of claim 9, wherein the projectile material is paper.

11. The method of claim 9 or 10, further comprising the step of applying a liquid to the projectile material directly after the projectile material is inserted into the one or more cavities.

12. The method of claim 9 or 10, further comprising the step of applying a liquid to the projectile material directly before inserting the projectile material into the one or more cavities.

13. The method of claim 9 or 10, wherein the pressing step further comprises of immersing the projectile mold into a liquid.

14. A method of making soft projectiles comprising:
selecting the mold of claim 8;
inserting a projectile material into the one or more cavities;
pressing the first plate against the second plate for a period sufficiently long to cause the projectile material to maintain a molded shape;
removing the first plate from contacting the second plate;
rotating the first plate 180 degrees vertically and up to 360 degrees horizontally, such that the one or more protrusions of the first plate are in contact with the base openings of the second plate; and
inserting the one or more protrusions of the first plate into the base openings of the second plate, pushing the soft projectiles out of the mold.

15. The method of claim 14, wherein the projectile material is paper.

16. The method of claim 15, wherein the inserting projectile material step further comprises of laying layers of projectile material on the upward facing surface of the second plate.

17. The method of claim 16, wherein the protrusions are sharp such that they cut the inserted projectile material when the first plate and the second plate are pressed together.

18. The method of claim 14 or 17, further comprising the step of applying a liquid to the projectile material directly after the projectile material is inserted into the one or more cavities.

19. The method of claim 14 or 17, further comprising the step of applying a liquid to the projectile material directly before inserting the projectile material into the one or more cavities.
